(19) United States
(12) Patent Application Publication
(10) Pub. No.: US 2008/0010584 A1
(43) Pub. Date: Jan. 10, 2008

(54) METHOD AND APPARATUS FOR PRESENTATION OF A PRESENTATION CONTENT STREAM

(75) Inventors: Anthony J. Corsetti, Royal Oak, MI (US); Nicolas Lhuillier, Versailles (FR); Jerome Picault, Paris (FR)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/428,683

(22) Filed: Jul. 5, 2006

(51) Int. Cl. G06F 17/00; G06F 15/00

(52) U.S. Cl. 715/201; 715/243

(57) ABSTRACT

A content presentation apparatus comprises a receiver receiving content items, such as individual adverts. A filter processor filters the content items in response to a user profile thereby generating a subset of content items associated with the user. The subset of content items may e.g. be stored in a data storage. The content presentation apparatus furthermore comprises a receiver receiving a presentation content stream. The presentation content stream may e.g. be a television signal received from a conventional television broadcast transmitter. An output processor presents the presentation content stream to the user. A user context processor determines a current user context for the presentation and a selection processor selects at least one content item from the subset of content items in response to the current user context. The output processor then overlays the selected content item(s) on the presentation content stream to generate a user adapted output.

### FIELD OF THE INVENTION

The invention relates to a method and apparatus for presentation of a presentation content stream and in particular, but not exclusively to presentation of a television presentation content stream.

### BACKGROUND OF THE INVENTION

In recent years, the availability and provision of multimedia and entertainment content has increased substantially. For example, the number of available television and radio channels has grown considerably and the popularity of the Internet has provided new content distribution means. Consequently, users are increasingly provided with a plethora of different types of content from different sources.

In line with the advances in distribution of content, there is an increased desire to target and adapt the provided content to the preferences and characteristics of the individual users. For example, there is a desire to provide more personalised advertising which is suitable for the individual's specific characteristics, desires, interests and current environment.

However conventional systems tend to be inflexible and incapable or unsuitable for providing user adapted content. For example, in many systems individual content streams are required to provide user adapted content resulting in high communication resource requirements.

Hence, an improved content presentation system would be advantageous and in particular a system allowing increased flexibility, facilitated implementation, reduced resource requirement, improved user customisation or adaptation and/or improved performance would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided a content presentation apparatus comprising: a first receiver for receiving content items; a filtering processor for filtering the content items in response to a user profile to generate a subset of content items associated with the user; a second receiver for receiving a presentation content stream; a presentation processor for presenting the presentation content stream to the user; a user context processor for determining a current user context for the presentation of the presentation content stream; a selection processor for selecting at least a first content item from the subset of content items in response to the current user context; and an overlaying processor for overlaying the first content item on the presentation content stream.

The invention may provide improved adaptation of presented content to a user. Specifically, the invention may allow an efficient system for adapting a presentation content stream to a user and the user's situation. A low complexity implementation may be achieved with reduced resource requirements. The invention may allow the same presentation content stream to be used for a large number of users while at the same time allowing the individual user to be presented with a user adapted version specifically adapted to the user. The invention may facilitate and/or reduce resource requirements for generation and/or distributing content while allowing user adapted/customised content to be presented to the individual user.

The use of a two stage process with separate evaluation of the user profile and current user context allows an efficient implementation and may specifically allow an advantageous partitioning of real time and non-real time processes.

The current user context may be updated in real time whereas the filtering and user profile update may be performed in non-real time and/or at a substantially lower frequency than the updating of the current user context.

The presentation content stream may e.g. be a television or radio programme stream having advert intervals which can be adapted to the individual user and the individual user's current situation.

According to an optional feature of the invention, the source of the first receiver is arranged to receive the content items from a first remote source and the second receiver is arranged to receive the presentation content stream from a different source.

The first and second receivers may be arranged to receive the content items and the presentation content stream via different communication means such as different communication links, different communication systems e.g. employing different communication standards and/or different communication networks.

The invention may allow an efficient distribution and individual optimisation of the communication parameters for the presentation content stream and the content items. For example, the presentation content stream may be distributed by a high capacity and/or real time communication means whereas the content items may be communicated using a lower capacity and/or non-real time communication means. The invention may allow a flexible system where common content and adaptation content may be generated and/or communicated independently.

According to an optional feature of the invention, the source of the first receiver is arranged to receive the content items via a non-broadcast communication link and the second receiver is a broadcast receiver arranged to receive the presentation content stream via a broadcast communication link.

This may allow an efficient real time distribution of a shared presentation content stream to a large number of users while allowing an efficient distribution of content for customisation. For example, a television program stream may be broadcast by a conventional television transmitter with customisation adverts being communicated through a network, such as the Internet or a wireless data network.

According to an optional feature of the invention, the filtering processor is arranged to filter the subset of contents independently of a timing of the presentation content stream and the apparatus further comprises a storage for storing the subset of content items.

This may allow an efficient implementation and/or a more efficient flexible resource usage.

According to an optional feature of the invention, the user context processor is arranged to determine the current user context in response to a content characteristic of the presentation content.

This may allow improved user customisation and may in particular allow adaptation to the characteristics of the content currently being presented to the user. The content characteristic may for example be determined in response to metadata associated with the presentation content stream and/or by a content analysis performed on the presentation content stream.

According to an optional feature of the invention, the apparatus further comprises a transceiver for communicating with a remote user device; and wherein the user context processor is arranged to determine the current user context in response to user context data received from the remote user device.

This may allow improved and/or more flexible adaptation to the user's current situation and/or may in particular allow a wider range of user context characteristics to be taken into account in the customisation.

According to an optional feature of the invention, the current user context comprises a plurality of concepts and the selection processor is arranged to select the first content item in response to an evaluation of a match between the plurality of concepts and characteristics of each of the content items of the subset of content items.

This may allow an efficient implementation and/or improved adaptation of the presented content. In particular, it may allow an efficient yet accurate adaptation of the content to the current user context. New concepts for the user context may repeatedly be generated with new concepts replacing existing concepts. Specifically, the current user context may be implemented as a First In First Out (FIFO) buffer containing a predetermined number of concepts.

According to an optional feature of the invention, the selection processor is arranged to generate a match indication for each of the content items of the subset of content items and to select the content item having a highest match indication as the first content item, the selection processor further being arranged to generate the match indication for a content item by combining weighted match indications between individual concepts of the current user context and corresponding characteristics of the content item.

This may allow a particularly advantageous implementation and/or performance. The corresponding characteristics of the content item may for example be determined in response to metadata for the content item and/or a content analysis of the content item.

According to an optional feature of the invention, the filtering processor is arranged to match characteristics of a received content item with corresponding user preference data of the user profile and to select whether to include the received content item in the first subset in response to the match.

This may allow a particularly advantageous implementation and/or performance. In particular, it may allow a practical selection of possible replacement content which matches the user profile. For example, potential overlay adverts that are particularly suited to the user may be determined by a low complexity operation. For example, metadata received for the content items can be matched to the user profile.

According to an optional feature of the invention, the overlaying processor is arranged to overlay the first content item on the presentation content stream by replacing at least some of the presentation content stream with the first content item.

This may allow a desirable adaptation in many embodiments.

According to an optional feature of the invention, the overlaying processor is arranged to overlay the first content item on the presentation content stream by combining at least some of the presentation content stream with the first content item such that both the first content item and at least some of the presentation content stream is simultaneously presented to the user.

This may allow a desirable adaptation in many embodiments. The combining may specifically be such that the first content item is presented as an integral part of the presentation of the presentation content stream while simultaneously presenting at least some of the presentation content stream.

For example, an advert content item may be overlaid a visual presentation by allowing the advert to be shown in only part of the presented image.

According to an optional feature of the invention, the apparatus further comprises a time indication receiver for receiving time indications for the presentation content stream, the time indications indicating time intervals in which overlaying is allowed and time intervals in which overlaying is not allowed; and wherein the overlaying processor is arranged to adjust a timing of the overlaying of the first content item in response to the time indications.

This may allow an improved user experience and/or facilitated implementation. For example, the feature may allow an efficient way of limiting the adaptation to specific time intervals thereby allowing e.g. the provider of the presentation content stream some control over the content which is presented. The time indications may for example be indications of specific time, relative or absolute time instants associated with the time intervals or may e.g. be a marker embedded in the presentation content stream and indicating the presence of the time intervals. For example, the presentation content stream may comprise a marker at the beginning and end of an interval in which overlaying is permitted.

In some embodiments, the time indications may for example indicate advert blocks in which advert content items of the first subset may be overlaid to provide a user adapted advert block.

According to an optional feature of the invention, the apparatus further comprises a requirement receiver for receiving overlay content item requirements for the presentation content stream, the overlay content item requirements indicating requirements of content items that must be met to allow overlaying of the content item stream; and wherein the overlaying processor is arranged to overlay the first content item in response to the overlay content item requirements.

This may allow an improved user experience and/or facilitated implementation. For example, the feature may allow an efficient way of limiting the adaptation to specific types of content items thereby allowing e.g. the provider of the presentation content stream some control over the content which is presented.

According to an optional feature of the invention, the apparatus further comprises a processor for determining characteristics of the overlaying of content items and a communication processor for communicating the characteristics to a remote server.

This may allow remote functionality, such as remote billing or management functionality, to monitor the local operation and adaptation to the user. The characteristics of the overlaying of content items may e.g. comprise an indication of how frequently a content item (or a group of content items) of the subset is used. The remote server may for example be a billing server.

According to an optional feature of the invention, the presentation content stream comprises overlay time intervals for overlaying by content items and wherein the apparatus is arranged to present the non-overlaid presentation content stream during the overlay time intervals if the selection processor determines that the subset of content items does not comprise a content item sufficiently matching the current user context.

This may allow an improved user experience, a facilitated and/or more flexible management and operation and/or a facilitated operation. For example, if no specifically user appropriate advert is found in the subset, a default advert of the presentation content stream may be presented.

According to an optional feature of the invention, the second receiver is a television broadcast receiver and the presentation content stream is a television program stream.

The invention may allow an improved adaptation of television broadcasts to the individual users.

According to a second aspect of the invention, there is provided a method of presenting a content stream; the method comprising: receiving content items; filtering the content items in response to a user profile to generate a subset of content items associated with the user; receiving a presentation content stream; presenting the presentation content stream to the user; determining a current user context for the presentation of the presentation content stream; selecting at least a first content item from the subset of content items in response to the current user context; and overlaying the first content item on the presentation content stream.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates a content distribution system in accordance with some embodiments of the invention;

FIG. 2 illustrates a presentation device in accordance with some embodiments of the invention;

FIG. 3 illustrates an example of a method of operation for a presentation device in accordance with some embodiments of the invention; and

FIG. 4 illustrates an example of a method of operation for a presentation device in accordance with some embodiments of the invention.

### DETAILED DESCRIPTION OF SOME EMBODIMENTS OF THE INVENTION

The following description focuses on embodiments of the invention applicable to user adaptation of television broadcasts and in particular to user adaptation of advert items of advert blocks of the broadcast. However, it will be appreciated that the invention is not limited to this application but may be applied to many other systems, services, signals and content types.

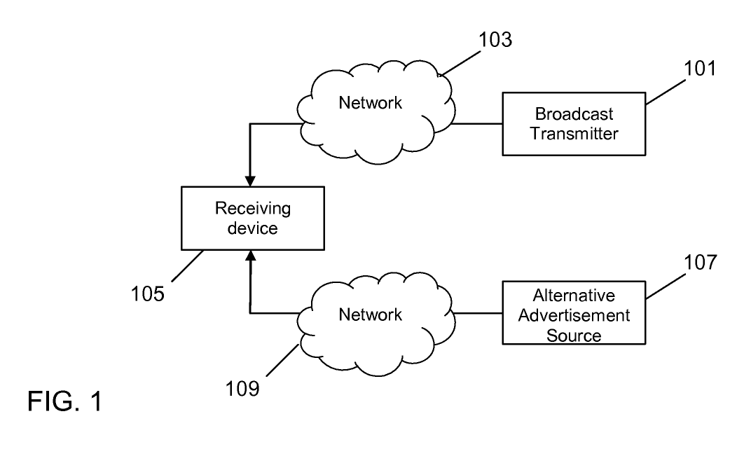

FIG. 1 illustrates a content distribution system in accordance with some embodiments of the invention.

FIG. 1 illustrates a source for a presentation content stream which in the specific example is a television broadcast transmitter 101 transmitting a television presentation stream of programme material. In the example the television presentation content stream comprises television programmes with individual advert time intervals wherein a number of adverts are presented. The television broadcast transmitter 101 is a conventional broadcast transmitter that broadcasts analogue or digital television signals to a large number of users in a relatively large geographical area. For clarity and brevity, the following description will assume a distribution of digital content items in the form of digitally encoded (e.g. MPEG-2 or 4) television programmes but it will be appreciated that the described principles may be applicable to other types of content items.

In the system of FIG. 1 the television signal is transmitted over a network 103 which can represent an over the air or cable broadcast of the signal or can e.g. represent a multi-purpose data network such as the Internet.

The system comprises a least one presentation device 105 which is able to receive the television broadcast from the broadcast transmitter 101 and which can present and/or record the received television content on a local storage.

The system furthermore includes an alternative advert source 107, which is arranged to communicate with device 105 through a suitable network 109. Similarly to the first network 103, the second network 109 can represent an over the air or cable broadcast of the advert content items or can e.g. represent a multi-purpose data network such as the Internet. The alternative advert source 107 is arranged to send content items to the presentation device 105 that can be used to adapt the received television presentation content stream to the individual user. Specifically, the alternative advert source 107 can transmit adverts to the presentation device 105 which can replace adverts of the presentation content stream received from the television broadcast transmitter 101.

In some embodiments, the alternative advert source 107 may be part of the television broadcast transmitter 101 or may be controlled and operated by the same operator. Also, in some embodiments, the first and second networks 103, 109 may be the same network and indeed in some embodiments the alternative advert source 107 and the television broadcast transmitter 101 may be integrated and the replacement adaptation advert clips can be transmitted from the television broadcast transmitter 101 either separately or as part of the presentation content stream.

However, in the embodiments described in the following, the alternative advert source 107 is separate to and independent of the television broadcast transmitter 101 and the presentation content stream and the adaptation content items are transmitted through different communication means. Thus, in the embodiments, the television broadcast transmitter 101 is not part of the advert replacement system. This allows a service provider controlling the alternative advert source 107 to be independent of the content broadcaster controlling the transmitter 101.

In the embodiments, the networks 103 and 109 are different communication systems and in particular, the first network 103 is a broadcast network providing an efficient distribution of a high data rate presentation content stream to a large number of users over a large geographic area. The first network 103 is specifically a conventional terrestrial or satellite television signal distribution network. The second network 109 is a communication network suitable for communication of a lower amount of data and typically to a lower number of users in typically a smaller geographical area. For example, whereas the first network 103 may be a countrywide broadcast network the second network 109 may e.g. cover only a single city.

Furthermore, whereas the first network 103 typically requires a high cost infrastructure, the second communication network may be a more inexpensive implementation of the required communication means. Indeed, in some embodiments, general data networks, such as the Internet, may be used for the communication of the adaptation content items. Thus, an advert adaptation overlay system can be implemented for a television broadcast system in a localised area and/or independently of the operator of the television broadcast system and/or without requiring any modifications to the television broadcast system.

In the embodiments, the presentation device 105 comprises functionality for presenting the received television signal to a user. The presentation device 105 can furthermore overlay the presented television signal by advert content from the alternative advert source 107. The alternative advert source 107 is selected to suit the specific user as well as the current environment/situation of the user thereby allowing an adaptation of the presented advertising to the specific user. A two step selection process is used for the replacement advertising content thereby allowing an efficient and low complexity implementation.

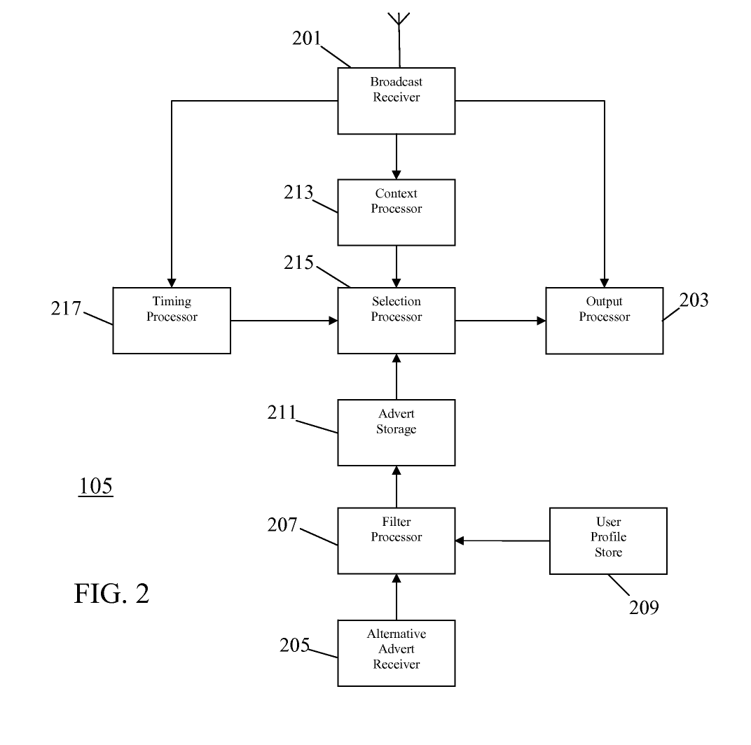

FIG. 2 illustrates the presentation device 105 in more detail. The illustrated functional blocks provide a personalised and contextualised advert overlay of the received broadcast television signal. Specifically, the presentation device uses a two-step filtering process, where one process uses a user profile (e.g. a user preference profile) and the other uses current context information to transparently substitute an advert of the presentation content stream with a personalised/contextualized advert using an overlay technique.

The presentation device 105 provides functionality for adapting the received presentation content stream by advert substitution, either partially or completely (i.e. full-screen replacement) using an overlay technique. This is achieved by a two-step process:
First, advert content items are received from the alternative advert source 107 e.g. with some descriptive information associated. The presentation device 105 pre-filters the advert content items based on a user profile containing e.g. user preferences and/or socio-demographic information. Selected adverts are stored in the presentation device 105. This pre-filtering step may be performed in real-time, or as a batch process (e.g. at night).
Then, when the user is presented with the presentation content stream, a second mechanism selects in real-time the adverts to be displayed from the stored adverts. This selection is based on current context information related to the current user(s). This context information can be inferred by the presentation device 105 based on local information (such as usage records), interaction with other devices, etc.

The approach may for example allow user targeted adverts to be displayed over standard adverts without the user being aware that replacement is taking place.

The presentation device 105 comprises a broadcast receiver 201 which can receive the television signals broadcast from the television broadcast transmitter 101 and can extract the television presentation content stream therefrom.

The broadcast receiver 201 is fed to an output processor 203 which presents the presentation content stream to the user(s). Specifically, the output processor 203 outputs the signal to a television display.

The presentation device 105 furthermore comprises an alternative advert receiver 205 which receives the adaptation advert content items from the alternative advert source 107. The adaptation advert content items are in the example received through a data network 109 but may in other embodiments be received via other means. For example, in some embodiments, the adaptation advert content items can be received on a separate television channel transmitted by the television broadcast transmitter 101. In such embodiments, the broadcast receiver 201 and the alternative advert receiver 205 may be the same functional unit.

The alternative advert receiver 205 is coupled to an advert filter processor 207 which is coupled to a user profile store 209 in which a user profile is stored for the user(s) of the presentation device 105. A user profile stores a number of characteristics associated with the user and can for example contain socio-demographic information, as well as special user interests (preferences). These interests can be specified explicitly by the user(s) and/or learned from the behaviour of the user.

The user profile is a relatively static characterisation of the user's characteristics and is updated at a slow rate in comparison to the content variations of the presentation content stream.

The advert filter processor 207 uses the user profile to filter the received advert content items from the alternative advert source 107. Thus, some of the received content items are rejected because they are considered not to match the user profile whereas other content items are retained because they are considered to match the user profile. Thus, the advert filter processor 207 generates a subset of content items which match the user profile by filtering the received content items.

Specifically, when the alternative advert receiver 205 receives a new advert content item, the advert filter processor 207 extracts metadata associated with the new content item. Alternatively or additionally, the advert filter processor 207 performs a content analysis on the received content item to generate content information.

Algorithms and techniques for content analysis are known to the skilled person and it will be appreciated that any suitable algorithm may be used without detracting from the invention.

The advert filter processor 207 implements a matching function which evaluates the relevance of the advert to the user e.g. based on a matching between advert metadata and data from the user profile. It will be appreciated that any suitable matching function or algorithm can be used without detracting from the invention.

The advert filter processor 207 is coupled to an advert storage 211 in which the advert content items that pass the filter criteria are stored.

The broadcast receiver 201 is furthermore coupled to a context processor 213 which is arranged to identify the current context of the user. The current context of the user reflects characteristics of the current experience, situation or environment for the user. Thus, whereas the user profile reflects characteristics of the user, the user context reflects characteristics of the user's current situation. Furthermore, whereas the user profile changes relatively slowly, the user context may change in real time.

The context processor 213 may specifically determine the user context in response to characteristics of the content of the received presentation content stream. For example, it may determine a genre for current programme (e.g. football, documentary etc).

The context processor 213 is coupled to an advert selection processor 215 which is further arranged to select replacement advert content items from the stored subset of content items depending on the current user context. Thus, the selection processor 215 can specifically select an advert that is appropriate for the current content being presented from a set of adverts that have already been found to be suitable for the user.

The selection processor 215 is furthermore coupled to the output processor 203 which can overlay the selected content item(s) on the presentation content stream such that the selected content items are presented to the user.

Thus, the output processor 203 is in charge of rendering the presentation output as either the original stream with no replacement or by overlaying the selected replacement advert content items over the whole or part of the original stream.

In the example, the presentation device 105 furthermore comprises a timing processor 217 which is coupled to the broadcast receiver 201 and the selection processor 215. The timing processor 217 determines the timing of the overlaying of the presentation content stream by stored content items.

Specifically, timing indications can be received for the presentation content stream which indicates when the overlay can be performed. For example, the timing processor 217 can use timing indications in the received stream to identify timeslots available for advert overlay. When such a timeslot is detected, the selection processor 215 uses the information provided by the context processor 213 to select adverts to be displayed from the advert storage 215. These are then fed to the output processor 203 for rendering in the identified time interval.

In the specific embodiments, metadata is provided for the presentation content stream which indicates time intervals in which the overlaying can be performed. Such metadata can e.g. include flags to identify the start and end of the timeslot and/or can include an indication of the duration of the timeslot. In the specific embodiment, the flags are set by the television broadcaster and are embedded in the presentation content stream. Alternatively or additionally, the metadata can be transmitted through a separate/dedicated stream or channel. In that case, the metadata can be specified by the television broadcaster or by a third party and may require a subscription. The flags can also be set ahead of the actual start of the overlay timeslot (e.g. 30 seconds before) to provide time for selection of the appropriate adverts. If the duration of the selected advert(s) does not match the actual length of the replacement timeslot, the remaining time can be filled with default adverts of a short duration.

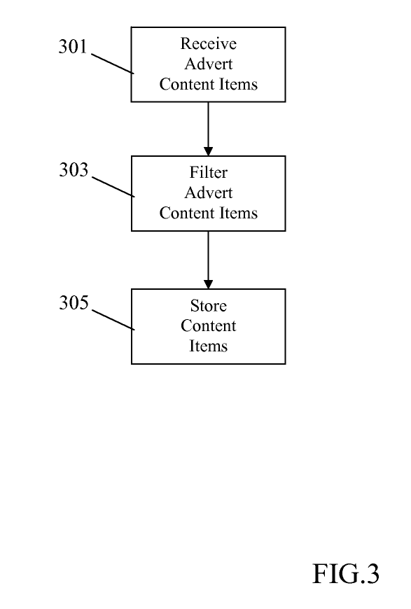

FIG. 3 illustrates an example of the pre-filtering task performed by the presentation device 105 on the content items received from the alternative advert source 107. The content item retrieval and filtering task can be performed by a batch process and independently of any timing of the presentation content stream.

In step 301, the alternative advert receiver 205 receives the content items from the alternative advert source 107.

When a new content item is received, the method continues in step 303 wherein the advert filter processor 207 filters the content items depending to determine if the content item matches the user profile. If so, the method continues in step 305 wherein the content item is stored in the advert storage 211. The method then returns to step 301.

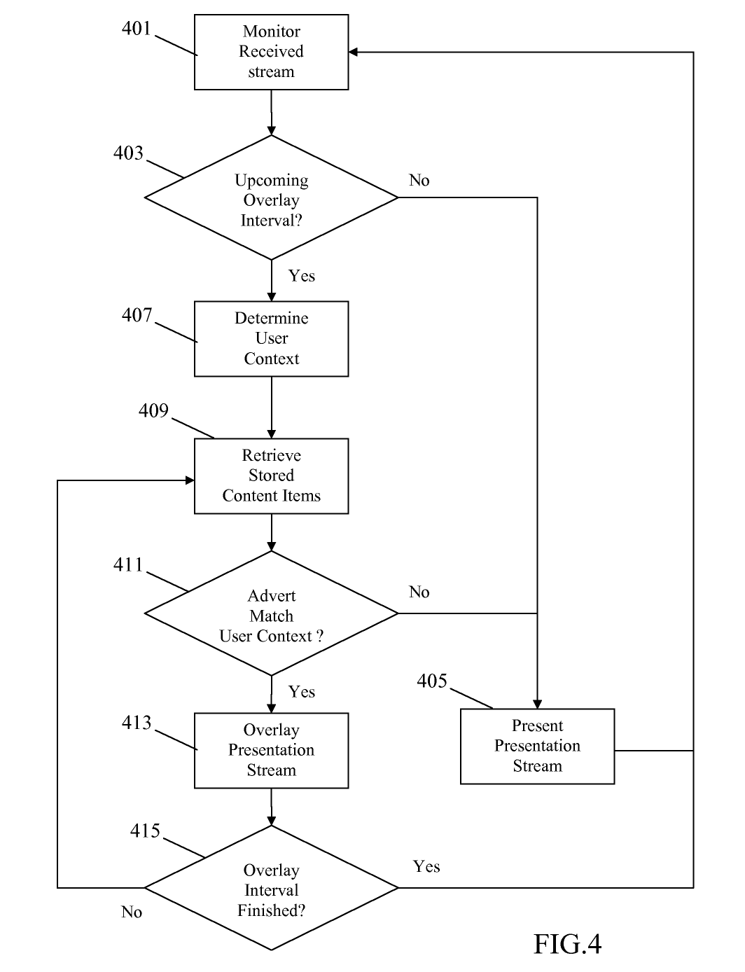

FIG. 4 illustrates the real-time process that allows the dynamic selection of adverts from the stored subset.

In step 401, the timing processor 217 monitors the received presentation content stream.

In step 403, it is evaluated if any indication of an upcoming overlay time interval is detected. If not, the output processor 203 continuous to present the received presentation content stream in step 405.

If an indication of an overlay time interval is detected, the method proceeds in step 407 after step 403. In step 407, the context processor 213 determines the current user context.

Step 407 is followed by step 409 wherein the stored content items are retrieved from the advert storage 211.

In step 411, the selection processor 215 determines if an advert matching the user context is available. If not, the method proceeds in step 405 wherein the received presentation content stream is presented during the overlay interval, i.e. in this case, no overlaying is performed.

Otherwise, step 411 is followed by step 413 wherein the output processor 203 overlays the selected content item on the presentation content stream.

Step 413 is followed by step 415 wherein the timing processor 217 determines if the overlay timing interval is finished. If so, the method continues in step 401 and otherwise, the method continues in step 409 to evaluate if any further overlaying should be performed.

Thus the method allows the presentation device 105 to select which adverts to display at a given time based on a correlation between the immediate context and metadata associated with the adverts stored on the device.

In the specific example, the adaptation advert content items are received with associated metadata. This metadata can directly relate to the content of the advert and can e.g. contain the following marketing information:
Product Information
   brand
   name
   price range
   keywords
   etc.
Advert Information
   Duration
   format (size, type)
   targeted audience described by:
      demographic attributes (sex, age, etc.)
      social attributes (profession, etc.)
   validity (expiration date)
   selection rules

The metadata may also contain links to other media, such as an alternate stream of video.

In the described embodiments, the immediate context C of a user is defined as a fixed size vector of weighted concepts:

C={(c₁;w₁), . . . , (cᵢ;wᵢ), . . . , (cₙ; wₙ)}

where:
cᵢ represents concept i; and
wᵢ represents the weight of this concept.

The immediate context is determined by extracting concepts from different context sources. Rules may optionally be used to assign a weight to concepts, based on some criteria. For example, a program that the user has recently watched may play a more significant role in advert selection than a program watched several hours ago, or the weight may also depend on the nature of the context source.

The immediate context may be extracted from a number of context sources, such as for example:
Programmes or content the user previously watched;
Past conversations (text or voice using a voice to text translator to extract concepts);
Current and recent locations.

Furthermore, in some embodiments, context information may be received from external user devices associated with the user. Thus, context information may be obtained not only from the presentation device 105 but also from surrounding user's devices (e.g. mobile phone, PDA etc) using suitable communications means (e.g. a Wireless Local Area Network (WLAN)).

In some embodiments, the user context contains a fixed number of concepts. In such an example, new concepts can replace older ones (using a First In First Out FIFO model) in order to represent the latest context of the user. Concepts may range from simple keywords (which are reduced to their stem and by synonymy) to actual ontology elements.

The current context vector C is compared to the metadata associated with each advert stored in the advert storage 211 and the selection processor 215 selects the advert resulting in the best match, i.e. the maximum match value. In the specific embodiments, the comparison is performed by computing a weighted scalar product between the context vector and the vector of metadata.

An example of such a metric between two concepts x and y is given by:

$$Similarity ( x , y ) = A {\sum }_{i} Similarity ( {x}_{i} , {y}_{i} ) \times {w}_{i}$$

where xᵢ and yᵢ represent the different elements of the vectors, wᵢ is the weighting for the concept i, A is a normalising factor and Similarity(xᵢ,yᵢ)=1 if xᵢ=yᵢ, 0 otherwise.

It will be appreciated that the methods of FIGS. 3 and 4 may be operated with independent timing requirements and/or constraints and/or characteristics. For example, the method of FIG. 3 may be operated independently of the timing of the processing of the presentation content stream and in particular may be operated independently of when the overlay is performed. Specifically, the method of FIG. 4 may be operated as a real time application whereas the method of FIG. 3 may be a non-real time application and may e.g. utilise batch processing.

In some embodiments, the presentation content stream is associated with data describing specific requirements for e.g. the content or type of overlay messages that can be used. For example, metadata can be received for each overlay time interval specifying characteristics of content items that are required in order for the content item to be selected. The selection processor 215 can then impose this condition on any matching content items and only if the requirements are met will the content item be overlaid.

For example, the metadata may specify that for a given overlay time interval, no content items that is not approved for general viewing can be included. The selection processor 215 can then determine if a matching content item is associated with restricted viewing and if so, the content item is rejected. This can provide the broadcaster with some control over the overlaying and can for example ensure that unsuitable adverts are not presented during e.g. a children's programme.

In some embodiments, the requirements may alternatively or additionally relate to the overlaying itself and may for example define constraints for partial ad overlay (size, position, etc.).

In some embodiments, the presentation device 105 may furthermore comprise a processor which determines characteristics of the overlaying of content items. For example, the processor can record which content items are overlaid, when and in connection with which television programmes. The recorded information can then be transmitted to a remote server where the information can be used for example to charge the advertisers in accordance with the actual usage of the adverts.

It will also be appreciated that the described approach is not limited to a broadcast source, but can apply to any presentation content stream and specifically to any audiovisual stream such as one received from e.g. a DVD, or similar form of media: audio (radio), e-books, etc.

It will be appreciated that the described embodiments can provide a number of benefits. Specifically, conventional methods of television advertising deliver identical adverts to all the viewers in a geographic area. In this paradigm, the only available method of user adaptation is to include a particular advert during a programme where the audience is expected to match the desired demographic for the product being advertised. In contrast, the described embodiments provide enhanced functionality.

In particular, it can provide an efficient system for user adaptation of adverts, wherein
Presented adverts are based on both user characteristics and user context (while separating the processing required for evaluating these).
The same architecture is generally applicable to many forms of media (TV, DVD, PVR, radio, etc).
The system supports many types of advertising that are often suggested as potential future replacements for conventional adverts: virtual product placement, ad mosaics, scrolling text, corporate logos, etc. This can in particular be achieved through a partial overlay of the presentation content stream by the selected content item.
The use of an overlay technique allows a seamless transition from conventional advertising, such that switching to this technology can be completely transparent to users.
The system can contain measures for privacy protection because advert matching is performed on the client side (user information is not required to be transmitted outside of the user's devices). This also eliminates the need for large amounts of centralized computer processing.
The system can make adverts less tedious to view by better matching them to the actual interests of the viewer, not only through personalization, but also based on the mood of the viewer at the moment they are watching the advert (the current context). This provides a double benefit of making adverts more interesting to the user, while also making them more effective for the advertiser.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A content presentation apparatus comprising:
a first receiver for receiving content items;
a filtering processor for filtering the content items in response to a user profile to generate a subset of content items associated with the user;
a second receiver for receiving a presentation content stream;
a presentation processor for presenting the presentation content stream to the user;
a user context processor for determining a current user context for the presentation of the presentation content stream;
a selection processor for selecting at least a first content item from the subset of content items in response to the current user context; and
an overlaying processor for overlaying the first content item on the presentation content stream.

2. The apparatus of claim 1 wherein the source of the first receiver is arranged to receive the content items from a first remote source and the second receiver is arranged to receive the presentation content stream from a different source.

3. The apparatus of claim 1 wherein the source of the first receiver is arranged to receive the content items via a non-broadcast communication link and the second receiver is a broadcast receiver arranged to receive the presentation content stream via a broadcast communication link.

4. The apparatus of claim 1 wherein the filtering processor is arranged to filter the subset of contents independently of a timing of the presentation content stream and the apparatus further comprises a storage for storing the subset of content items.

5. The apparatus of claim 1 wherein the user context processor is arranged to determine the current user context in response to a content characteristic of the presentation content.

6. The apparatus of claim 1 wherein the apparatus further comprises a transceiver for communicating with a remote user device; and wherein the user context processor is arranged to determine the current user context in response to user context data received from the remote user device.

7. The apparatus of claim 1 wherein the current user context comprises a plurality of concepts and the selection processor is arranged to select the first content item in response to an evaluation of a match between the plurality of concepts and characteristics of each of the content items of the subset of content items.

8. The apparatus of claim 7 wherein the selection processor is arranged to generate a match indication for each of the content items of the subset of content items and to select the content item having a highest match indication as the first content item, the selection processor further being arranged to generate the match indication for a content item by combining weighted match indications between individual concepts of the current user context and corresponding characteristics of the content item.

9. The apparatus of claim 1 wherein the filtering processor is arranged to match characteristics of a received content item with corresponding user preference data of the user profile and to select whether to include the received content item in the first subset in response to the match.

10. The apparatus of claim 1 wherein the overlaying processor is arranged to overlay the first content item on the presentation content stream by replacing at least some of the presentation content stream with the first content item.

11. The apparatus of claim 1 wherein the overlaying processor is arranged to overlay the first content item on the presentation content stream by combining at least some of the presentation content stream with the first content item such that both the first content item and at least some of the presentation content stream is simultaneously presented to the user.

12. The apparatus of claim 1 further comprising a time indication receiver for receiving time indications for the presentation content stream, the time indications indicating time intervals in which overlaying is allowed and time intervals in which overlaying is not allowed; and wherein the overlaying processor is arranged to adjust a timing of the overlaying of the first content item in response to the time indications.

13. The apparatus of claim 1 further comprising a requirement receiver for receiving overlay content item requirements for the presentation content stream, the overlay content item requirements indicating requirements of content items that must be met to allow overlaying of the content item stream; and wherein the overlaying processor is arranged to overlay the first content item in response to the overlay content item requirements.

14. The apparatus of claim 1 further comprising a processor for determining characteristics of the overlaying of content items and a communication processor for communicating the characteristics to a remote server.

15. The apparatus of claim 1 wherein the presentation content stream comprises overlay time intervals for overlaying by content items and wherein the apparatus is arranged to present the non-overlaid presentation content stream during the overlay time intervals if the selection processor determines that the subset of content items does not comprise a content item sufficiently matching the current user context.

16. The apparatus of claim 1 wherein the second receiver is a television broadcast receiver and the presentation content stream is a television program stream.

17. The apparatus of claim 1 wherein the content items are advertising content items.

18. The apparatus of claim 1 wherein the presentation content stream is an audiovisual stream and the content items are audiovisual content items.

19. A method of presenting a content stream; the method comprising:
receiving content items;
filtering the content items in response to a user profile to generate a subset of content items associated with the user;
receiving a presentation content stream;
presenting the presentation content stream to the user;
determining a current user context for the presentation of the presentation content stream;
selecting at least a first content item from the subset of content items in response to the current user context; and
overlaying the first content item on the presentation content stream.

20. A computer program product enabling the carrying out of a method according to claim 19.
